(19) United States
(12) Patent Application Publication
(10) Pub. No.: US 2008/0065504 A1
(43) Pub. Date: Mar. 13, 2008

(54) Electronic Auction Aggregation

(75) Inventors: David Newmark, Tarzana, CA (US); Randolph Wang, Torrance, CA (US)

Correspondence Address: FULBRIGHT AND JAWORSKI LLP, 555 S. FLOWER STREET, 41ST FLOOR, LOS ANGELES, CA, 90071, US

(73) Assignee: Newmark Communications, Inc.,, Encino, CA (US)

(21) Appl. No.: 11/531,675

(22) Filed: Sep. 13, 2006

Related U.S. Application Data
(60) Provisional application No. 60/825,109, filed on Sep. 8, 2006.

(51) Int. Cl. G06Q 30/00

(52) U.S. Cl. 705/26

(57) ABSTRACT

A method enables a seller to bid in multiple electronic reverse auctions. The method includes determining auctions for which the seller is eligible, informing the seller of the eligible auctions, and receiving a selection indicating which of the eligible auctions the seller will participate in. The method also includes receiving a single bid from the seller, and applying the single bid to each of the selected auctions. Based upon the single bid, as well as bids from other sellers, winnings are determined for each of the selected auctions.

### CROSS REFERENCE TO RELATED APPLICATIONS

This application claims the benefit of U.S. provisional patent application. No. 60/825,109 filed on Sep. 8, 2006, the disclosure of which is expressly incorporated by reference herein in its entirety.

The present disclosure is related to the subject matter of U.S. patent application Ser. No. 10/959,295 to NEWMARK, filed on Oct. 5, 2004, the disclosure of which is expressly incorporated by reference herein in its entirety.

### BACKGROUND OF THE INVENTION

1. Field of the Invention

The present disclosure relates to auctions. More particularly, the present disclosure relates to aggregating multiple auctions to facilitate the placement of bids within the multiple auctions.

2. Background

Commodities can be sold at auctions. One example of an auctioned commodity is advertisement space marketed by a media carrier to prospective advertisers.

The reverse auction format can be advantageous to the purchaser in that the reverse auction places the sellers in direct competition for the advertising dollar. In known reverse auctions, each buyer creates an auction specifying criteria that indicates who will be eligible to bid in the auction. The eligible bidders can then place individual bids in each auction. A disadvantage of such a system is that the seller cannot easily bid in multiple auctions. For example, if a seller has fifty items available and one of the auctions includes a buyer seeking fifty or more items, the seller can only commit those items to a single auction, just in case all items are sold in that auction. Therefore, the seller's winnings are limited because the seller is prevented from bidding in other auctions, even if committed items are not sold in the first auction entered. In addition, even when more inventory is available than being sought, it is cumbersome to manage multiple different auctions, also possibly reducing potential winnings.

Thus, a need exists to help a seller bid in multiple reverse auctions.

### SUMMARY

According to an aspect of the present invention, a method enables a seller to easily bid in multiple electronic reverse auctions. The method includes determining auctions for which the seller is eligible, informing the seller of the eligible auctions, and receiving a selection indicating which of the eligible auctions the seller will participate in. The method also includes receiving a single bid from the seller and applying the single bid to each of the selected auctions. Based upon the single bid, as well as bids from other sellers, winnings are determined for each of the selected auctions.

In one embodiment, the method also includes displaying a total amount of winnings, that is a sum of winnings for each selected auction, and/or winnings for each selected auction.

The single bid can be a minimum bid. In this case, the winnings are determined by calculations based upon increased bids. The increased bids include a first increased bid that is higher than the minimum bid and a second increased bid that is higher than a minimum bid from another seller.

In another embodiment, the method also includes receiving an adjusted single bid from the seller, and applying the adjusted single bid to each selected auction. New winnings are determined in each of the selected auctions based upon the adjusted single bid and bids from other sellers. The method can also include receiving an alternate bid from another seller, and determining revised winnings based upon the received alternate bid.

In still another embodiment, the single bid includes a number of available advertising spots and a cost for each advertising spot. The winnings can indicate a number of won advertising spots and a dollar amount. The dollar amount is based upon the number of won advertising spots and a winning price for each advertising spot.

According to another aspect of the present invention, a method enables a seller to bid in multiple electronic reverse auctions. In this aspect, the seller controls multiple entities. The method includes determining auction(s) for which each controlled entity is eligible, informing the seller of the eligible auction(s) for each controlled entity, and receiving a selection indicating which eligible auction(s) each entity will participate in. The method also includes receiving a single bid from the seller for each controlled entity, and applying the received single bids to each of the selected auctions. Winnings are determined in each of the selected auctions for each controlled entity, based upon the received single bids and bids from other sellers.

According to another aspect of the present invention, a computer readable medium stores a computer program for enabling a seller to bid in multiple electronic reverse auctions. The medium includes a determining code segment that determines auctions for which the seller is eligible, an informing code segment that informs the seller of the eligible auctions, and an auction selection receiving code segment that receives a selection indicating which of the eligible auctions the seller will participate in. The medium also includes a bid receiving code segment that receives a single bid from the seller, and an applying code segment that applies the single bid to each of the selected auctions. The medium also stores a winnings code segment that determines winnings in each of the selected auctions, based upon the single bid and bids from other sellers.

In one embodiment, the medium also stores a total winnings displaying code segment that displays a total amount of winnings including a sum of winnings for each selected auction, and/or an auction winnings displaying code segment that displays winnings for each selected auction.

The single bid can be a minimum bid. In this case, the winnings code segment also includes a calculating code segment that calculates winnings based upon increased bids. The increased bids include a first increased bid that is higher than the minimum bid and a second increased bid that is higher than a minimum bid from another seller.

In another embodiment, the medium stores an adjusted bid receiving code segment that receives an adjusted single bid from the seller, an adjusted bid applying code segment that applies the adjusted single bid to each of the selected auctions, and a new winnings code segment that determines new winnings in each of the selected auctions, based upon the adjusted single bid and bids from other sellers. The medium can also include an alternate bid receiving code segment that receives an alternate bid from another seller, as well as a revised winnings code segment that determines revised winnings based upon the received alternate bid.

In still another embodiment, the single bid includes a number of available advertising spots and a cost for each advertising spot. The winnings can be a number of won advertising spots and a dollar amount. The dollar amount is based upon the number of won advertising spots and a winning price for each advertising spot.

According to another aspect, a computer readable medium stores a program for enabling a seller to bid in a plurality of electronic reverse auctions. The seller controls multiple entities. The medium includes an eligible auction code segment that determines auction(s) for which each controlled entity is eligible, an informing code segment that informs the seller of the eligible auction(s) for each controlled entity, and a selection receiving code segment that receives a selection indicating which eligible auction(s) each entity will participate in. The medium also stores a single bid receiving code segment that receives a single bid from the seller for each controlled entity, and an applying code segment that applies the received single bids to each of the selected auctions. The medium further stores a winnings code segment that determines winnings in each of the selected auctions for each controlled entity, based upon the received single bids and bids from other sellers.

### BRIEF DESCRIPTION OF THE DRAWINGS

In the drawings, wherein like reference numerals refer to similar components:

FIG. 1 schematically illustrates an implementation of a method of facilitating placement of an advertisement;

FIG. 2 schematically illustrates a second implementation of a method of facilitating placement of an advertisement;

FIG. 3 is a flowchart illustrating a method of facilitating placement of an advertisement;

FIG. 4 shows an exemplary auction selection screen, according to an aspect of the present invention;

FIG. 5 shows an exemplary bidding screen, according to an aspect of the present invention;

FIG. 6 shows another exemplary bidding screen including a revised bid, according to an aspect of the present invention; and

FIG. 7 shows an exemplary winnings screen, according to an aspect of the present invention.

### DETAILED DESCRIPTION

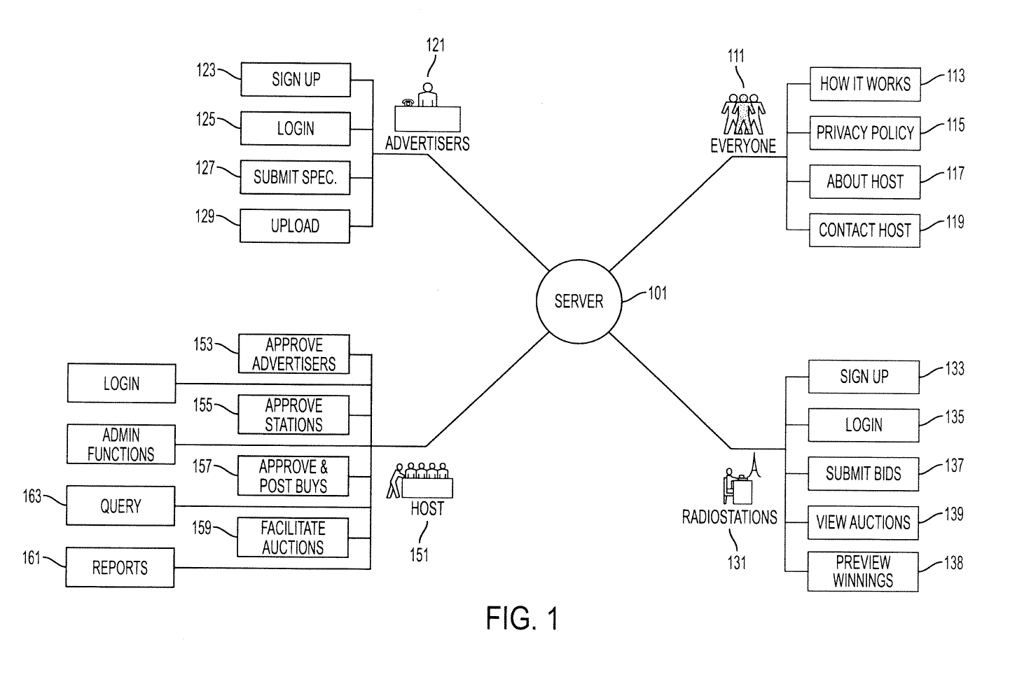

Turning in detail to the drawings, FIG. 1 schematically illustrates a system for implementing an auction, such as a reverse auction. While the following describes media advertisements as the commodity being sold, the description is equally applicable to any type of commodity and is not limited to advertisements placed in media, such as print ads, television broadcasts, internet ads, and the like. The present invention encompasses auctions of any type of item or service. Moreover, although a reverse auction is being described, the present invention is also believed to encompass standard auctions.

In the description below, the exemplary auction is intended to allow advertisers to purchase advertising space (“avails”) that remains unsold in the one week time period prior to the week including the desired “on-air” time. In one embodiment, requests to purchase avails (post an auction) are submitted up until a preset deadline, (for example until noon Wednesday for the following Monday) before the targeted week (running Monday through Sunday) of “on-air” time and the auctions are initiated approximately six days prior to the start of the target week. Bids on the auction are accepted for a predetermined period, for example one day, at which time auctions are closed and the winning bidder(s) is/are notified. Thereafter, the advertisements are run by the winning bidder(s) in accordance with the terms and conditions of the auction. The present invention is, however, not limited to use solely within the aforementioned context, as the auction parameters may vary widely without altering the essence of the invention.

The system includes a network server 101 connected to the Internet. The network server 101 allows interested parties to access stored information via a series of web pages, communicate electronically and complete desired transactions. The network server 101 is also configured to provide the host, advertisers, and media carriers with automatic email notices where and when appropriate. Such automatic notification greater facilitates the purchase transactions described herein.

The network server 101 may be accessed by the various parties either directly through a direct network connection or other method, such as a dial-up connection, or indirectly over a public network such as the internet. Different parties have different levels of access to information residing on the network server 101. In general, everyone 111 is provided limited access to the stored information. The limited amount of information available to everyone 111 includes how the advertisement placement process works 113, the privacy policy 115 of the host 151, additional information 117 about the host 151 (including that information which the host wishes to make publicly available), and contact information 119, which enables interested parties to contact the host 151 directly.

Advertisers 121 and radio stations 131 are each given limited access to nonpublic information stored on the network server 101. Both advertisers 121 and radio stations 131 are permitted to change certain information which resides on the network server 101. Each of these parties is generally permitted to change the private contact information which is associated with each respective party. Where appropriate, the host 151 may direct the network server 101 to permit the advertisers 121 and radio stations 131 to change other information stored on the network server 101. For certain changes, the network server 101 may be configured to require host approval before those changes are integrated into the system. In general, the host 151 performs all administrative functions relating to the network server 101 that are necessary. Among these administrative functions is the ability to grant and deny access as desired.

The advertisers 121 are given access to the network server 101 to perform four primary functions, although additional secondary functions may also be granted. These four primary functions include signing up 123 as an advertiser to establish a private account, logging in 125 to a private account previously established, submitting specifications 127 in order to purchase advertising space, and uploading 129 creative material and/or funds to the network server 101 during the transaction process. The radio stations 131 are similarly granted access to four primary functions available on the network server 101. As with the advertisers 121, the radio stations 131 may also be granted access to secondary functions. The primary functions available to the radio stations 131 include signing up 133 as a radio station available to carry advertising, thereby establishing a private account, logging in 135 to an established account, submitting bids 137 in response to a specification posted by an advertiser, and previewing winnings 138 and reviewing available auctions 139.

As indicated, the host 151 has administrative access to the network server 101. This means that the host may view and change any information residing on the network server 101. In addition, the host 151 performs duties which further facilitate an advertiser's purchase of advertising space. These duties include pre-approving advertisers 153, pre-approving stations 155, approving and posting 157 specifications for an auction, generally facilitating 159 the auction process, and running queries 163 and reports 161 from the information stored on the network server. These queries 163 and reports 161 may be customized through standard programming interfaces to suit the needs of the host 151.

Before initiating any transactions, an advertiser signs up with the system and provides identifying information. The advertiser preferably provides this information by accessing one or more web pages stored on the network server 101 for this particular purpose. Basic contact information is requested: advertiser name, advertiser address, and the name, title, phone number, fax number and e-mail address of one or more individuals who will be authorized to access the network server on behalf of the advertiser. In addition, at this initial sign-up stage, the advertiser is asked to provide default instructions for handling excess funds following the close of an auction, in case a budget is not reached. Two different fund-handling options are detailed below. Upon receipt of this initial sign-up information, the host establishes an advertiser profile and prepares and provides paperwork to the advertiser to establish a contract whereby the advertiser agrees to abide by the terms and conditions of the services being provided by the host. Following completion of these formalities, the host activates the advertisers account on the network server 101.

Each advertiser's account has one or more authorized users associated therewith. Users fall into one of three categories: executive users, standard users, and read-only users. Each user has an associated user profile. Executive users can access all aspects of an account and perform any task associated with the account, including creating additional users of any type, editing the profile information associated with any user, and initiating or modifying any auction associated with the advertiser. Standard users can initiate auctions on behalf of the advertiser, but can only modify auctions that were created by that particular user. These standard users are also able to view any user profile, but they can only modify their own user profile. Read-only users are able to view all information associated with the advertiser, but cannot modify any information except for that particular user's own profile.

Media carriers also sign up via the web pages stored on the network server 101. The media carrier provides an account name and contact information for one or more users associates with the account. Where the media carrier is acting on behalf of one or more radio stations, the call letters of each radio station is also provided. The users associated with a media carrier may be granted one of three levels of access: executive users, standard users, and read-only users. The executive users can access all information associated with the media carriers account and may modify any of that information, including bids that are placed in response to an auction. Standard users can place bids for an auction, modify bids placed by that user, and modify their own respective profile. A media carrier having more than one radio station may optionally limit a standard user to placing bids on behalf of a selected subset of the radio stations controlled by that media carrier. Read-only users can read or view all information associated with the media carrier, but cannot modify any information except the information which is associated with the read-only user's profile.

Upon the media carrier's completion of the initial sign-up process, the host verifies that the station call letters entered by the media carrier are valid based upon known radio stations throughout the areas being served. Using the call letters, the host gathers additional information from an appropriate ratings service to complete the media carrier's profile. In radio, Arbitron, Inc. of New York, N.Y. is presently the sole provider of ratings in the radio market. Information that may be gathered from the rating service include each station's format, market, designated market area (DMA), and ratings in various demographic categories. The ratings are generally expressed in the form of an average quarter hour (AQH) for a given demographic audience. AQH is defined within the radio industry as the total number of listeners tuned in to a specific radio program for a minimum of five minutes within a fifteen minute period. When completing the profile information for a radio station, the host preferably averages the two most recent Arbitron ratings surveys to come up with an average AQH. Other methodologies of completing a radio station's profile information may also be used.

As with the advertisers, the media carriers are asked to complete necessary legal paperwork to insure that the media carrier agrees to abide by the established terms and conditions of the host. Such contracts preferably include terms whereby media carriers guarantee that the advertisements will air following a winning bid and that the advertisements are not preemptible. Following completion of the above formalities, the host activates the media carrier's account on the network server 101.

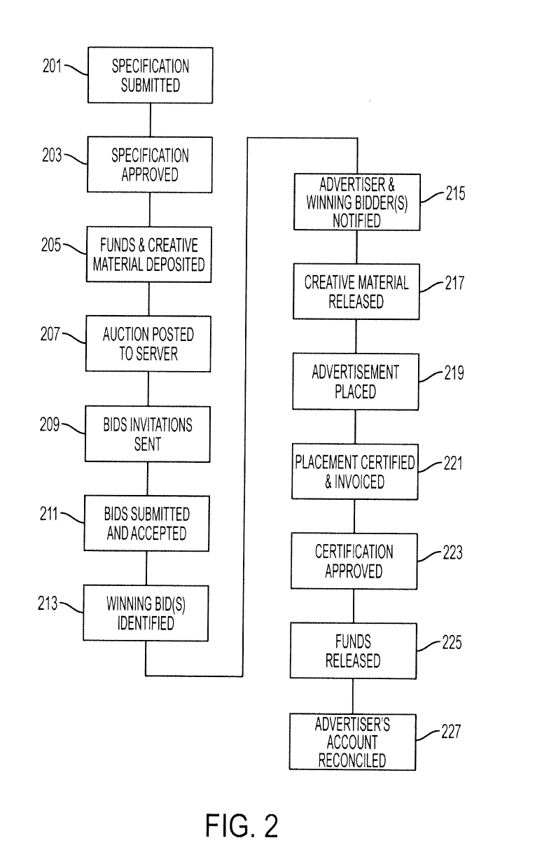

FIG. 2 is a flow chart which illustrates the process that the host, the advertiser, and the radio stations go through so that the advertiser may place an advertisement with a radio station. This process may be used by the advertiser to place a single advertisement with a single radio station, the advertisement running one or more times, or to place two or more advertisements with multiple radio stations, each advertisement running one or more times. In the latter instance, the advertiser is effectively creating an entire advertising campaign to advertise the product or service being sold.

To initiate a transaction for purchasing advertising space, the advertiser logs into an active account on the network server and, using web pages specifically designed for this task, enters the specification for placement of the advertisement. The advertiser may modify the specification at any time prior to approval of the specification by the host. The specification includes the following:
Advertiser. This identifies the name of the advertiser who is purchasing the advertising space. Preferably, the network server completes this information based upon the profile of the user creating the specification.
Advertising period. The advertiser identifies the desired week for running the advertisement(s).
Description. This includes a short description or overview of the purchase the advertiser wishes to make.
Budget. This is the maximum dollar amount the advertiser wishes to spend. The amount applies to all advertisements being placed through a single auction.
Demographic. This identifies the demographics the advertiser wishes to target. The advertiser may target specific gender and age groups. The categories of demographics available to an advertiser are preferably identical to the demographic categories used by Arbitron, Inc. Preferably, the gender options are male, female, and all adults, and the age options are 25+, 25-34, 5-44, 45-54, 55-64, and 65+.
Format. This identifies the advertiser's desired media format, e.g., the type of radio station or stations on which the advertiser wishes to place the advertisement. Many different media formats are available in radio, for example, talk radio, news, country, classical, pop, etc. The media format may also identify the language of the radio stations on which the advertisement is to be placed.
Day Parts. This identifies the time slot in which the advertiser wants to place the advertisement. Generally, within the radio industry, day parts are broken up into two segments, the day and the time. The day portion of the day parts includes Monday through Friday, Saturday, and Sunday. The time portion of the day parts include six different time periods: Rotator (6 a.m. to Midnight), Morning Drive or AM Drive (5 a.m. to 10 a.m.), Mid Day (10 a.m. to 3 p.m.), Afternoon Drive or PM Drive (3 p.m. to 7 p.m.), Night (7 p.m. to Midnight), and Overnight (Midnight to 5 a.m.). The advertiser may identify any one or multiple day parts in which the advertisement will be run. Where more than one day part is selected, the advertiser may be given the option to place a separate budgetary constraint on any given day part. By default, the only budget constraint placed on any single day parts is the budget for the auction as a whole. A separate budgetary constraint on a day part should be less than the total budget allocated for the auction and limits the amount the advertiser is willing to spend on advertisements placed within the constrained day part. Note that by placing a restriction requirement on the day parts, the advertiser places a de facto constraint on the budget of all day parts.
Market. The advertiser selects the market criteria for the radio stations on which the advertisement is to be placed. The market criteria identifies the radio advertising market or markets. In the U.S., the radio advertising market is broken up into 297 DMA's. Further, each market is ranked by Arbitron, Inc. The advertiser may select specified markets, may select markets based on the Arbitron rankings, may select the least expensive markets based on cost per thousands by demographics, or may use any other criteria for selecting markets.
Number of Spots. The advertiser identifies the number of advertisements (called spots) that will be placed through the auction.
Spot Length. The advertiser specifies the length of the advertisement(s). Preferably, the advertiser is given the option of two or more pre-defined spot lengths, such as thirty seconds and one minute lengths. Other spot length options may also be provided to the advertiser.
Type of Spot. The advertiser indicates the format of the advertisement(s) to be placed. Advertisements may consist of pre-produced audio that is provided to the radio station as a finished product and is ready for airing. Such advertisements are generally provided in a common computer-readable format, such as WAV, MP3, or the like. Finally, advertisements may consist of any combination of pre-produced audio and text. Regardless of the form of the advertisement, the advertiser provides detailed instructions for running the spot. In order for the processes described herein to proceed smoothly and without significant delays, the advertiser should have the spots in a ready-for-broadcast format at the time of submitting the specification for approval.
Traffic Instructions/Restrictions. The advertiser identifies criteria for running multiple advertisements within any particular day part. For example, the advertiser may require that a first advertisement runs twice within a selected day part, while a second advertisement runs three times within the same selected day part. If only a single advertisement is being placed, then the traffic instructions default to the advertisement being evenly rotated within all specified day parts.
Maximum Number of Spots Per Station or Day Part. The advertiser identifies the maximum number of spots to be run on any given station or during any single day part during a particular time period, preferably during any one week.
Maximum CPM. This is the reserve cost of the upcoming auction. CPM is defined as the cost per thousand listeners in a particular day part. The advertiser specifies a maximum CPM for placement of the advertisement in each of the day parts selected. Assuming that a bid meets all other criteria defined in a specification, the maximum CPM is the yardstick by which the bid is measured.

Following the advertiser's submission 201 of the specification, the host receives notice of the specification so that it can be reviewed to ensure it is ready for the bidding process. Should any information be missing from the specification, or should any additional information be necessary to complete the specification, the host contacts the advertiser to obtain the additional information and complete the specification. Once complete, and if such is appropriate, the host approves 203 the specification and the advertiser is notified of the approval. The advertiser thereafter transfers 205 the funds, equal to or above (for future usage) the total budget listed in the specification, and the creative material, i.e., the advertisement(s), to the host. The host maintains control of the funds and creative material during the course of the auction

After receipt of the funds and the creative material, the host posts the auction to the server 207. The network server is configured to automatically send out 209 bid invitations to radio stations that meet the format and market criteria of the specification upon posting of the new auction. In one embodiment, the specification also includes radio stations to be excluded. Thus, radio stations satisfying the market and format criteria which are listed as excluded will not receive invitations.

In one embodiment, a user controls multiple radio stations. In this case, the network server determines which radio stations each user controls, and then informs each user of all auctions to which the user controlled radio stations are invited.

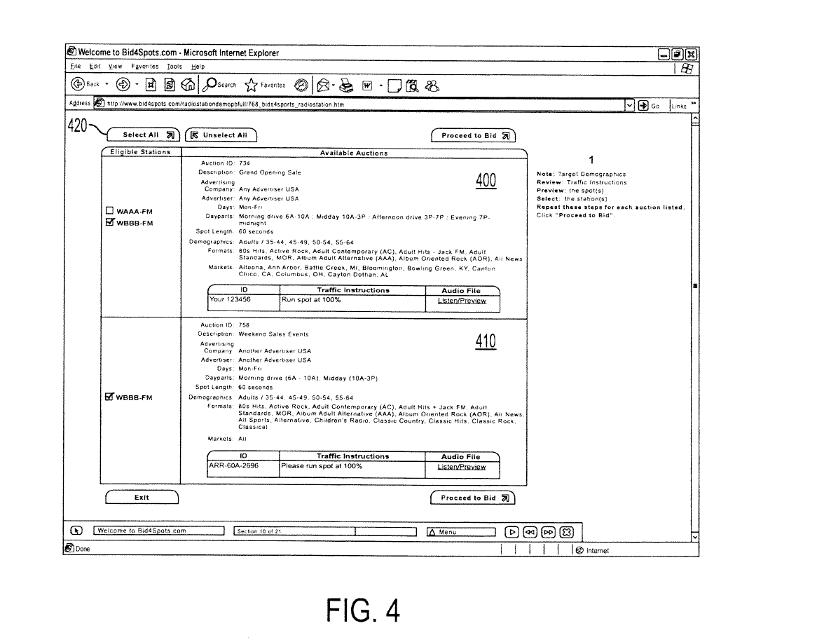

FIG. 4 shows an example of data displayed to the user when the user is ready to review and select auctions to which the user controlled radio stations have been invited. In FIG. 4, two radio stations (WAAA and WBBB) controlled by the user are eligible to bid in the first auction 400. Only one user-controlled radio station (WBBB) is eligible to bid in the second auction 410. Of course, more than two auctions can be available, however for this description, it will be assumed that only two auctions are available for this user. The user can select which stations will bid in each auction, for example by checking the appropriate boxes, or in the case that all radio stations should bid, selecting the “Select All” button 420. At this time, the user can also review each auction's requirements and listen to each auction's spots. The bidding media carriers preferably have access to all information in the specification with the exception of that information related to financials, e.g., the budget and the maximum CPM.

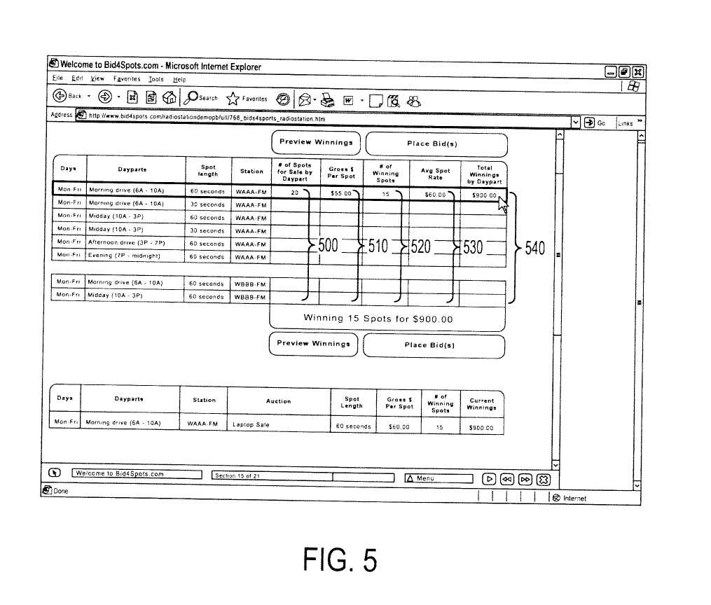

Once all desired stations are selected, the media carriers access the central server to submit 211 bids for carrying the advertisements. FIG. 5 shows exemplary bidding fields. In column 500, the user enters the number of spots available for sale for each day part and for each spot length. In FIG. 5, the user placed a bid to sell twenty 60 second spots for WAAA-FM during the Monday-Friday morning drive. The price is $55.00 for each spot.

It is noted that FIG. 5 shows more auctions than FIG. 4. For example, FIG. 5 shows thirty second spot lengths, although no such auction is shown in FIG. 4. The limited number of auctions shown in FIG. 4 is intended to simplify the explanation.

As noted above, the user enters an amount the user will accept for each spot in each day part ($55.00 in FIG. 5). In one embodiment, the amount entered is a minimum amount. Detailed description of the minimum value embodiment will be provided below.

Although a single bid is shown in FIG. 5, bid entries are submitted for each day part and also for each spot length. Bids are entered in a similar manner for each other radio station.

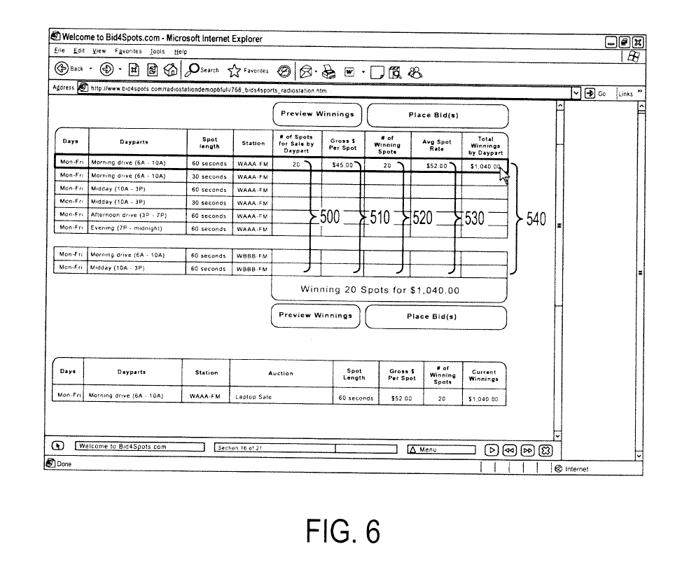

According to an aspect of the present invention, the user need only enter a single bid for each station, day part and spot length. That is, the user need not enter separate bids for each auction. Rather, the host bids on behalf of the user in every selected auction, based upon the bids entered by the user. For example, if three auctions have been selected for KAAA, and each selected auction includes a thirty second spot during the Monday-Friday AM drive, the host will place bids on behalf of KAAA in all three selected auctions. The bid will be based upon the single bid KAAA entered in FIG. 5 or 6 for a thirty second spot during the Monday-Friday AM drive. In order to bid in each auction, the host assumes the inventory of each radio station is infinite. More detailed description of the inventory control will be provided later.

The minimum rates entered in column 510 need only be a minimum because the host can raise the bids to obtain increased winnings. This calculation will also be described in more detail below. Although not shown, the bid entry screen could also include fields to receive the maximum value for each spot and a minimum number of spots required to be sold.

Once all bids are entered, the user can select a “Preview Winnings” button to preview the winnings that would occur with the bids just entered. FIG. 5 shows exemplary previewing winnings data. Column 520 shows the number of spots won for each daypart and column 530 shows the price to be paid for each spot. Of course, the price being paid will match the bid price designated in column 510 if the bid is not a minimum value, and will always be at least the minimum price designated in column 510 in the minimum price embodiment. Column 540 shows the total dollar value of the winnings by daypart, that is the value in column 520 multiplied by the value in column 530. In the example shown in FIG. 5, during the morning drive, station WAAA has won only 15 spots at $60 for each spot, totaling $900. The user has not sold his complete inventory in this example. However, the price is higher than his minimum, i.e., the minimum value embodiment is employed.

If the user is satisfied with the winnings, the user can submit the bids to the host. Otherwise, the user can return to the bidding screen to refine the bids. FIG. 6 shows a revised bid in which the user has lowered the minimum to be accepted for each spot to $45.00. In this case, the number of winning spots increases to 20, i.e., the total inventory available for sale. The spot rate is now $52.00. In this way, the user can continue to revise the bid until the user is satisfied with the winnings.

Of course, other users will also be bidding, which will change the winnings. Thus, the user should monitor the previewed winnings up until the auction closes, to ensure that the winnings are acceptable or if not, to further revise the bids.

All bids accepted by the network server are evaluated to determine the bid CPM for each day part that is bid upon. The CPM for each day part bid is calculated as the cost per spot of the bid divided by the AQH during that particular day part for the given demographic audience. For administrative purposes, the network server can rate the bid CPM for each day part according to an index which is scaled to have the maximum CPM in the specification correspond to a value of 100. The index may be linear such that a dollar decrease in the bid CPM results in a 1 point decrease in the index. Alternatively, the index may be curved using, for example, a logarithmic algorithm.

After the prearranged closing time of the auction, the network server identifies 213 all winning bids and sends out 215 notifications to the winning media carriers and to the advertiser. Winning bids are determined by ranking all accepted bids by the assigned index value. The bid with the lowest index value below 100 is the first winning bid. If two bids have the same index value, then the first submitted bid is the winning bid. If funds remain in the budget after the first winning bid is awarded, then the bid with the next lowest index value below 100 is also a winning bid. Again, if funds remain in the budget, then additional winning bids are identified. This process continues until either the funds in the budget are exhausted or there are no more bids having an assigned index value under 100.

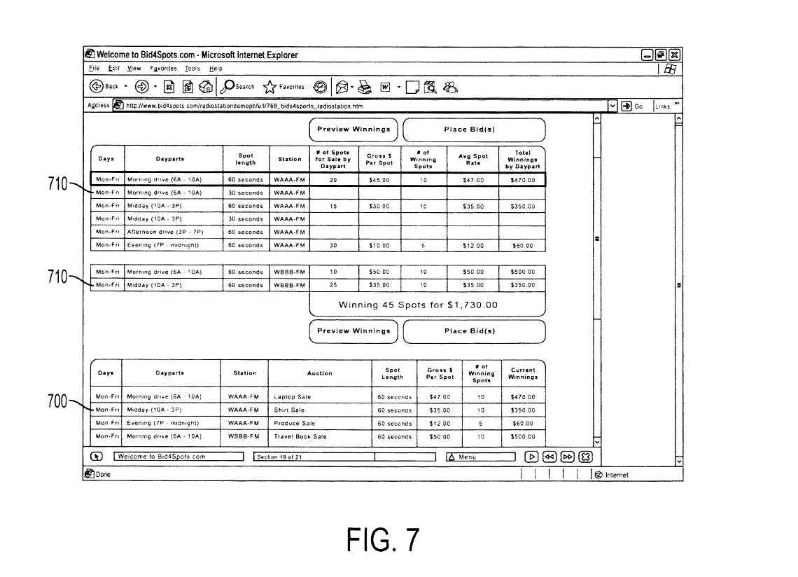

An exemplary screen showing awarded winnings is illustrated in FIG. 7. In FIG. 7, section 700 show details of the winning summary section 710. More specifically, section 700 describes which auctions have been won, including the name of the auction, in addition to the information provided in section 710.

Although riot shown, the winner notifications also include instructions on how the winning media carriers are to obtain the creative material and how they are to obtain payment following completion of the advertising run. By following the instructions in the winning bid notices, the creative material is released 217 to the winning media carriers. These winning media carriers place 219 the advertisements in accordance with the agreement established by the specification and the terms and conditions of the auction that are pre-established and maintained by the host.

After all advertisements have run as agreed upon, the winning media carriers submit 221 a certification that the advertisements ran as agreed, and may also submit 221 an invoice to the host via the network server. The host reviews and approves 223 the certification and invoice to determine if both meet with all the terms and conditions of the auction. Thereafter, funds are released 225 to the compliant media carriers. This process is repeated for each of the winning media carriers, after which the advertiser's account is reconciled 227 and any remaining funds in that account may be returned to the advertiser if such was previously requested. Otherwise, the funds remain on account for the advertiser's next auction.

As noted above, in one embodiment the user enters a minimum bid (rather than an absolute bid) and the system increases the bid without action by the user. Description of the incrementing is now provided.

The process begins after the host has received the selection of auctions, as well as the radio station bid for at least one daypart and spot length.

In one example (independent from the examples provided above), 100 sixty second spots in a Monday-Friday morning drive are available for sale for at least $40 per spot. An auction includes a maximum CPM of $20.00.

The host receives bids from other stations and calculates everyone's position assuming the stations are bidding at the minimum. All spots having a minimum bid that exceed the maximum CPM auction requirement are removed. An example with one day part is shown in Table 1. In this example, it is assumed that the auction specifies a maximum CPM at $20.00 Thus, stations 1 through 4 are still eligible in the auction after phase I. During phase I, inventory and budget constraints are ignored.

TABLE 1

| Station | CPM ($) |
|---|---|
| 1 | 10.20 |
| 2 | 12.22 |
| 3 | 14.20 |
| 4 | 18.22 |
| 5 | 26.11 |

In phase II, every bid is increased. In one embodiment, the bid beneath the highest eligible bid (station 3 in this example) is increased to match the CPM of the highest eligible station (station 4 in this example) minus a configurable value, e.g., $0.20. The process then repeats with the next lowest bid. In this example, station 2 to match station 3, and station 1 to match station 2. Although a $0.20 gap is described, the gap is adjustable via configuration. The result after the initial push in phase II is shown in Table 2:

TABLE 2

| Station | CPM ($) |
|---|---|
| 1 | 17.62 |
| 2 | 17.82 |
| 3 | 18.02 |
| 4 | 18.22 |
| 5 | 26.11 |

Using the increased bids, the winners for this auction are established, taking account of budget constraints. Because station 1 through 3 are effectively bidding at a higher amount for each spot, some of the stations that were eligible in Table 1 may not be winning because the budget is consumed by stations 1 to 3. In this example, it is assumed that station 4 is not winning because stations 1 to 3 have accounted for the entire budget specified in the auction.

The bids are then further increased to consume as much of the budget as possible. Starting with the bid of the lowest ranked winner (station 3), the bids are increased by the maximum amount calculated to be allowed while staying within the budget. In one embodiment, this push will not cause a winning bid to become a losing bid. Each other winning bid is increased in the same manner.

At this point, it is known that if every station has infinite inventory, these are their best possible positions.

Next, a ranking of all the bids occurs (as mentioned above), taking into account the other day parts within the same auction. That is, the bids are listed, lowest to highest, including all day parts of each auction. It is noted that every radio station is bidding in every auction in every day part with their best bid.

Table 3 shows exemplary bids ranked in order of lowest CPM to highest for all day parts of an auction. Those bids exceeding the maximum CPM are omitted from Table 3. The data in Table 3 includes the winning bids from the day part illustrated in Table 2 (e.g., PM drive), as well as the (not shown) winning bids from the other day parts in the same auction (e.g., AM drive).

TABLE 3
Bid Ranking

| Radio Station | Day Part | Bid CPM |
|---|---|---|
| Station 1 | PM drive | $17.62 |
| Station 2 | PM drive | $17.82 |
| Station 1 | AM drive | $17.85 |
| Station 4 | AM drive | $18.00 |
| Station 3 | PM drive | $18.02 |
| Station 5 | AM drive | $18.12 |

Table 4 shows the winning bids from this example, the number of spots the winning bidders will run, the day parts in which those spots will run, and the total cost to the advertiser for running those spots. The last-listed winning bidder is only awarded six of the seven spots that were included in the bid for the PM Drive day part. This limitation occurs because the maximum budget for the PM Drive day part listed in the specification (not shown) would be exceeded if all seven spots of the bid are awarded.

TABLE 4
Winning Bidders

| Radio Station | Day Part | # of Spots | Cost per Spot | Total Cost |
|---|---|---|---|---|
| Station 1 | PM drive | 20 | $98 | $1,960 |
| Station 2 | PM drive | 15 | $128 | $1,920 |
| Station 1 | AM drive | 22 | $320 | $7,040 |
| Station 4 | AM drive | 40 | $720 | $28,800 |
| Station 3 | PM drive | 6 | $620 | $3,720 |

After the initial ranking and awards, the best spread exists assuming all radio stations have infinite inventory. However, some radio stations may be awarded more spots then their available inventory. Therefore, some of the winnings need to be removed from the stations winning more spots than are available.

In one embodiment, the first radio station have its winnings reduced is the station requiring the most trimming. For example, if one station is winning 100 spots and it has 40 spots for sale, then 60 of its winning spots must be trimmed. In one embodiment, the winnings are trimmed from auctions that have the most bids that are eligible to win but could not win because of the competition. In other words, the budget has been exceeded but bids from other stations exist that do not exceed the maximum CPM. In Table 2, station 4 is one such bid that is eligible to win but could not win because of the competition.

After the trimmed station is removed, the winners in this auction are recalculated, and the process repeats with the next auction(s) until this radio station's inventory can support the number of winning spots specified by the station. The process repeats itself for the next radio station that requires trimming, until all stations' winnings are equal to or less then their available inventory.

The last step is to refill any gap that is created by trimming the winnings. In order to refill the gaps, the host starts with the bid of the lowest ranked winner, and increases the bid by the maximum amount calculated to be allowed while staying within the budget. This process is similar to the process previously described.

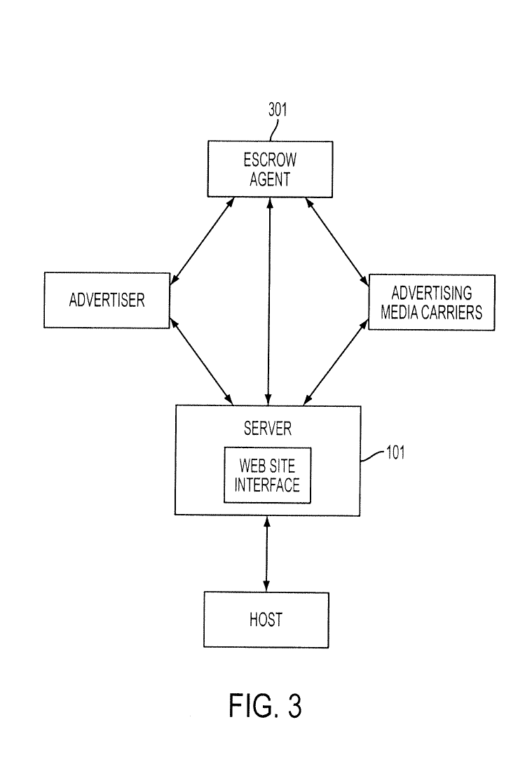

FIG. 3 illustrates an alternative embodiment that includes a third party escrow agent 301. The escrow agent 301 is provided limited, read-only access to the network server 101 to obtain the contact information of parties to transactions involving the escrow agent 301 and to check on the status of those transactions. The escrow agent 301 acts as a neutral third party with whom the budgeted funds and creative material are deposited for the duration of the auction process. The network server 101 enables the other parties to a transaction to communicate with the escrow agent 301 and provides automatic notices to alert the escrow agent 301 as to funds and creative materials that are being deposited, when such funds and creative materials should be released, and to whom they should be released. Thus, in such an embodiment, the escrow agent 301 essentially takes over the previously-described duties of the host in all respects with regard to the funds and the creative material.

Thus, an improved way to easily place bids within multiple auctions is disclosed. The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

In a particular embodiment, a disk drive unit may include a computer-readable medium in which one or more sets of instructions, e.g. software, can be embedded. Further, the instructions may embody one or more of the methods or logic as described herein. In a particular embodiment, the instructions may reside completely, or at least partially, within the main memory, the static memory, and/or within the processor during execution by a computer system. The main memory and the processor also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions or receives and executes instructions responsive to a propagated signal so that a device connected to a network can communicate voice, video or data over the network. Further, the instructions may be transmitted or received over the network via the network interface device.

While the computer-readable medium is discussed as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for enabling a seller to bid in a plurality of electronic reverse auctions, comprising:
determining a plurality of auctions for which the seller is eligible;
informing the seller of the plurality of eligible auctions;
receiving a selection indicating which of the eligible auctions the seller will participate in;
receiving a single bid from the seller;
applying the single bid to each of the selected auctions; and
determining winnings in each of the selected auctions, based upon the single bid and bids from other sellers.

2. The method of claim 1, further comprising displaying a total amount of winnings comprising a sum of winnings for each selected auction.

3. The method of claim 1, further comprising displaying winnings for each selected auction.

4. The method of claim 1, in which the single bid comprises a minimum bid.

5. The method of claim 4, in which the determining winnings further comprises calculating winnings based upon increased bids, the increased bids including a first increased bid that is higher than the minimum bid and a second increased bid that is higher than a minimum bid from another seller.

6. The method of claim 1, further comprising:
receiving an adjusted single bid from the seller;
applying the adjusted single bid to each of the selected auctions; and
determining new winnings in each of the selected auctions, based upon the adjusted single bid and bids from other sellers.

7. The method of claim 6, further comprising receiving an alternate bid from another seller; and determining revised winnings based upon the received alternate bid.

8. The method of claim 1, in which the single bid comprises a number of available advertising spots and a cost for each advertising spot.

9. The method of claim 8, in which the winnings comprise a number of won advertising spots and a dollar amount, the dollar amount being based upon the number of won advertising spots and a winning price for each advertising spot.

10. A method for enabling a seller to bid in a plurality of electronic reverse auctions, the seller controlling a plurality of entities, the method comprising:
determining auction(s) for which each controlled entity is eligible;
informing the seller of the eligible auction(s) for each controlled entity;
receiving a selection indicating which eligible auction(s) each entity will participate in;
receiving a single bid from the seller for each controlled entity;
applying the received single bids to each of the selected auctions; and
determining winnings in each of the selected auctions for each controlled entity, based upon the received single bids and bids from other sellers.

11. A computer readable medium storing a computer program for enabling a seller to bid in a plurality of electronic reverse auctions, comprising:
a determining code segment that determines a plurality of auctions for which the seller is eligible;
an informing code segment that informs the seller of the plurality of eligible auctions;
an auction selection receiving code segment that receives a selection indicating which of the eligible auctions the seller will participate in;
a bid receiving code segment that receives a single bid from the seller;
an applying code segment that applies the single bid to each of the selected auctions; and
a winnings code segment that determines winnings in each of the selected auctions, based upon the single bid and bids from other sellers.

12. The medium of claim 11, further comprising a total winnings displaying code segment that displays a total amount of winnings comprising a sum of winnings for each selected auction.

13. The medium of claim 11, further comprising an auction winnings displaying code segment that displays winnings for each selected auction.

14. The medium of claim 11, in which the single bid comprises a minimum bid.

15. The medium of claim 14, in which the winnings code segment further comprises a calculating code segment that calculates winnings based upon increased bids, the increased bids including a first increased bid that is higher than the minimum bid and a second increased bid that is higher than a minimum bid from another seller.

16. The medium of claim 11, further comprising:
an adjusted bid receiving code segment that receives an adjusted single bid from the seller;
an adjusted bid applying code segment the applies the adjusted single bid to each of the selected auctions; and
a new winnings code segment that determines new winnings in each of the selected auctions, based upon the adjusted single bid and bids from other sellers.

17. The medium of claim 16, further comprising an alternate bid receiving code segment that receives an alternate bid from another seller; and
a revised winnings code segment that determines revised winnings based upon the received alternate bid.

18. The medium of claim 11, in which the single bid comprises a number of available advertising spots and a cost for each advertising spot.

19. The medium of claim 18, in which the winnings comprise a number of won advertising spots and a dollar amount, the dollar amount being based upon the number of won advertising spots and a winning price for each advertising spot.

20. A computer readable medium storing a program for enabling a seller to bid in a plurality of electronic reverse auctions, the seller controlling a plurality of entities, the medium comprising:
an eligible auction code segment that determines auction(s) for which each controlled entity is eligible;
an informing code segment that informs the seller of the eligible auction(s) for each controlled entity;
a selection receiving code segment that receives a selection indicating which eligible auction(s) each entity will participate in;
a single bid receiving code segment that receives a single bid from the seller for each controlled entity;
an applying code segment that applies the received single bids to each of the selected auctions; and
a winnings code segment that determines winnings in each of the selected auctions for each controlled entity, based upon the received single bids and bids from other sellers.
